(19) United States
(12) Patent Application Publication
(10) Pub. No.: US 2019/0080296 A1
(43) Pub. Date: Mar. 14, 2019

(54) SYSTEM, APPARATUS, AND METHOD FOR GENERATING TESTING SCHEDULES FOR STANDARIZED TESTS

(71) Applicant: Education Advanced, Inc., Tyler, TX (US)

(72) Inventors: J. Eli Crow, Tyler, TX (US); Jason Graham, Tyler, TX (US)

(21) Appl. No.: 15/826,450

(22) Filed: Nov. 29, 2017

Related U.S. Application Data
(63) Continuation of application No. 15/702,244, filed on Sep. 12, 2017.

(51) Int. Cl. G06Q 10/10; G09B 5/12; G09B 5/10

(52) U.S. Cl. CPC G06Q 10/1093; G09B 5/12; G09B 5/10

(57) ABSTRACT

The disclosure provides a test scheduler for generating testing schedules for standardized tests. In one embodiment, the test scheduler includes at least one interface for receiving a plurality of inputs from a user and at least one external source, and a processor configured to perform a test scheduling algorithm to generate a testing schedule for a testing campus. The test scheduling algorithm generates a series of input prompts and decisions based on the plurality of inputs, wherein the plurality of inputs includes at least testing parameters and student and teacher data and the teacher data includes at least a roster of teachers and teacher schedules.

### CROSS-REFERENCE TO RELATED APPLICATION

This application is a continuation of U.S. patent application Ser. No. 15/702,244, entitled “SYSTEM, APPARATUS, AND METHOD FOR GENERATING TESTING SCHEDULES FOR STANDARIZED TESTS”, filed on Sep. 12, 2017. The above-listed application is commonly assigned with the present application and is incorporated herein by reference as if reproduced herein in its entirety.

### TECHNICAL FIELD

This disclosure relates to standardized testing schedules and, more specifically, creating an optimal schedule to conduct standardized testing based on a plurality of inputs

### BACKGROUND

Standardized testing is used in the United States education system for measuring a student's performance, and likewise, a school or educator's performance, at various grade and course levels. For example, the state of Texas offers the STAAR (State of Texas Assessments of Academic Readiness) test, a standardized test, to students in at least public schools beginning in third grade. Students are tested in various subjects at each grade or course level, including reading, math, writing, science, and various other subjects.

Each school campus is typically configured differently from any other campus and each group of students is unique. Various factors are taken into consideration when planning and creating a testing schedule for each campus.

### SUMMARY

In one aspect, the disclosure provides a test scheduler comprising at least one interface for receiving a plurality of inputs from a user and at least one external source; and a processor configured to perform a test scheduling algorithm to generate a testing schedule for a testing campus, wherein the test scheduling algorithm generates a series of input prompts and decisions based on the plurality of inputs. The plurality of inputs may include at least testing parameters and student and teacher data, the teacher data including at least a roster of teachers and teacher schedules. In one embodiment, the test scheduler may be further configured to verify that inputs from the user do not violate district or state regulations related to teacher certification, student accommodation requirements and designated support requirements.

In another aspect, the disclosure provides a test scheduling system. The system comprises a test scheduler configured to generate a test schedule; and at least one external computing device configured to supply student and teacher data to the test scheduler for the test schedule; wherein the test scheduler includes: at least one interface for receiving a plurality of inputs from the at least one external computing device; a memory, the memory storing a test scheduling computer program product; and a processor configured to execute a test scheduling algorithm and prepare based thereon a testing schedule for a testing campus, wherein the test scheduling algorithm generates a series of input prompts and decisions based on the plurality of inputs; wherein the plurality of inputs includes at least testing parameters and student and teacher data, the teacher data including at least a roster of teachers and teacher schedules.

In yet another aspect, the disclosure provides a method for coordinating a standardized test, the method comprising: receiving data for a testing campus, the data including at least school district information and campus information; receiving testing parameters; receiving student and teacher data from at least one external source, the teacher data including at least a roster of teachers and teacher schedules; receiving student testing accommodations required; receiving past performance data for each test and student; and preparing a testing schedule for the testing campus using the received data, the testing parameters, student and teacher information, testing accommodations, and past performance data; wherein the processing and preparing the testing schedule is performed by a processor stored on a non-transitory computer readable medium.

### BRIEF DESCRIPTION

Reference is now made to the following descriptions taken in conjunction with the accompanying drawings, in which:

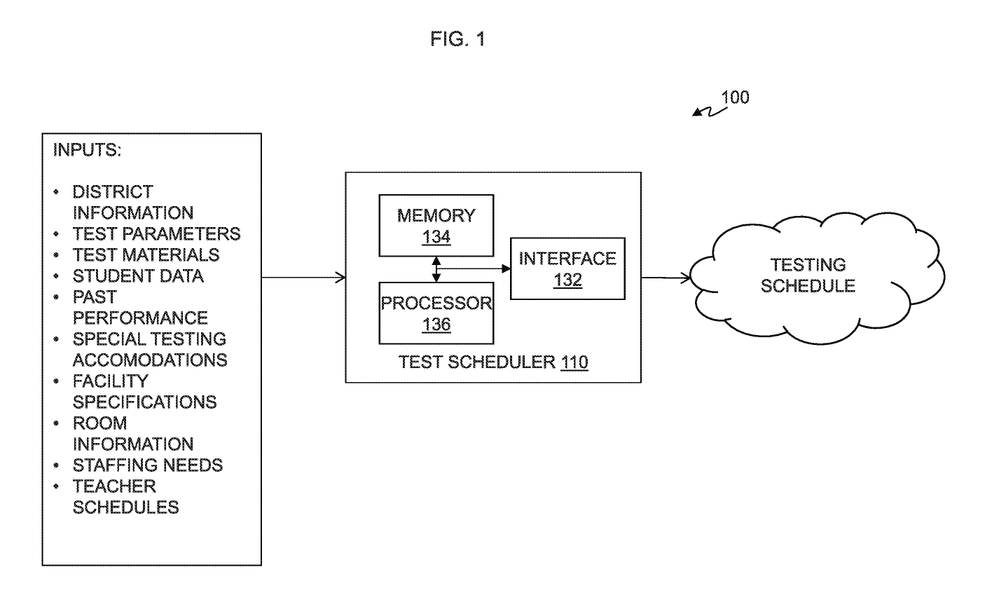

FIG. 1 illustrates a diagram of an embodiment of a test scheduling system for creating a testing schedule for an individual school campus carried out according to the principles of the disclosure;

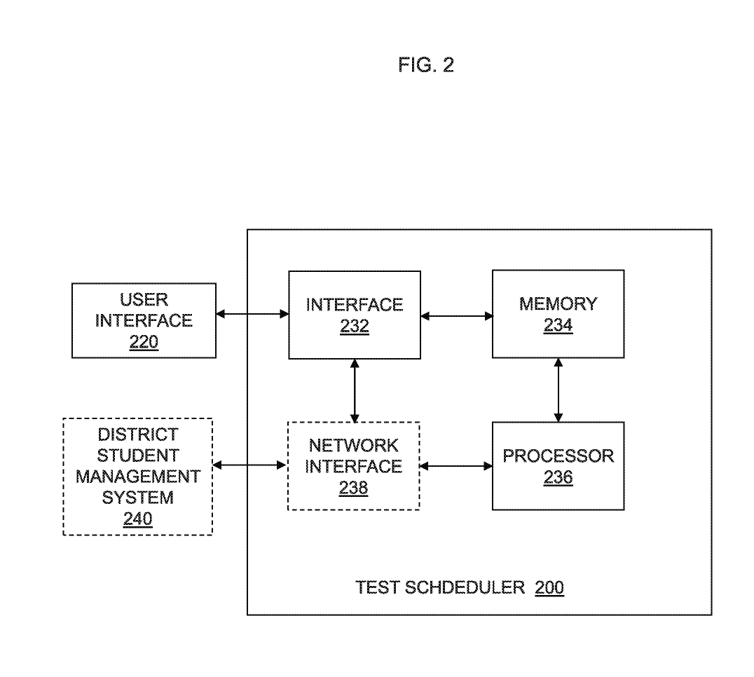

FIG. 2 illustrates a block diagram of one embodiment of a test scheduler constructed according to the principles of the disclosure;

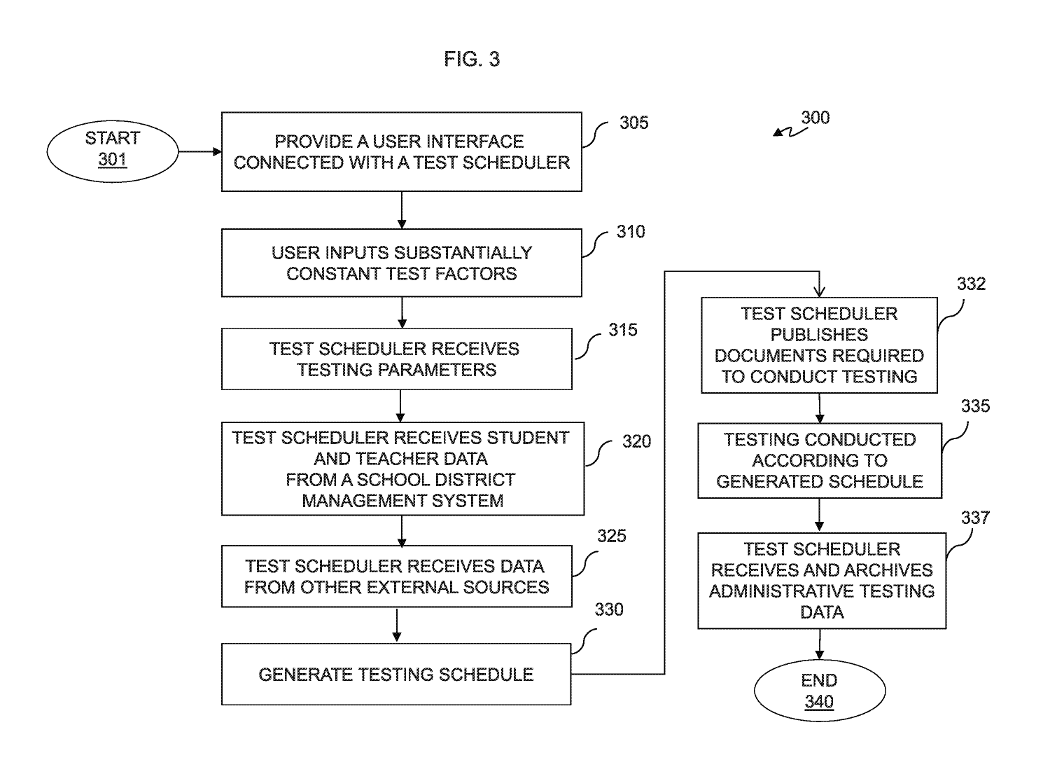

FIG. 3 illustrates a flow diagram of an embodiment of a method for creating a testing schedule and conducting a standardized test according to the created testing schedule carried out according to the principles of the disclosure;

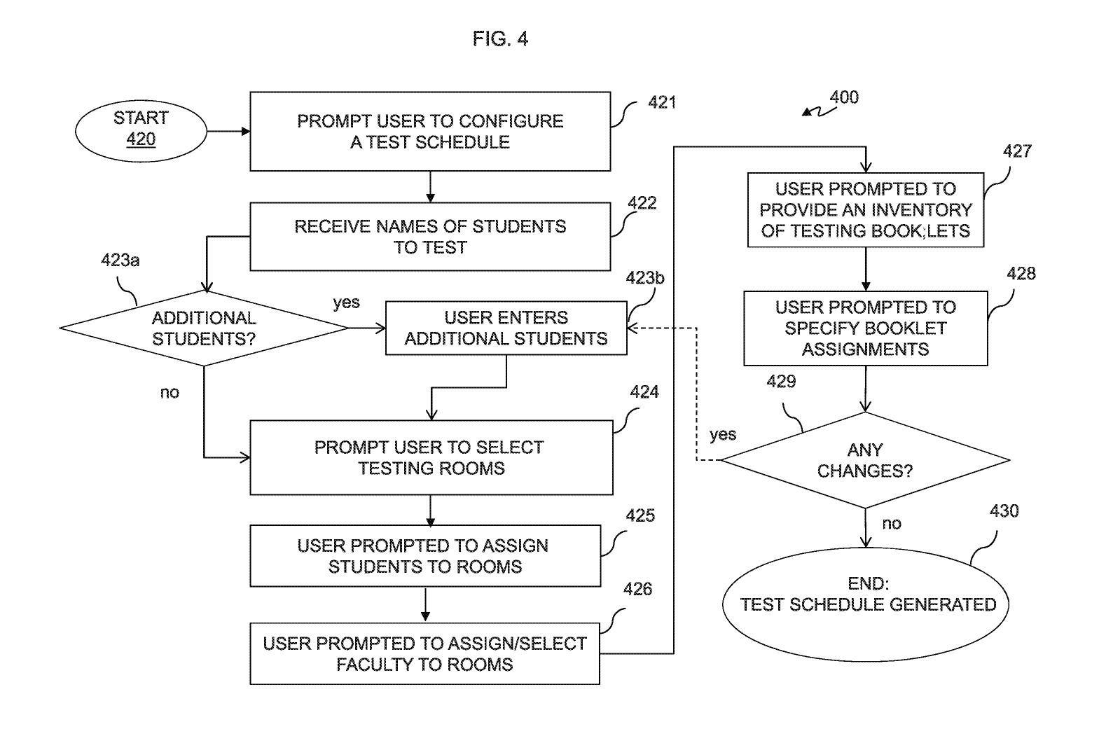

FIG. 4 illustrates a flow diagram of an example of a method corresponding to a test scheduling algorithm executed according to the principles of the disclosure; and

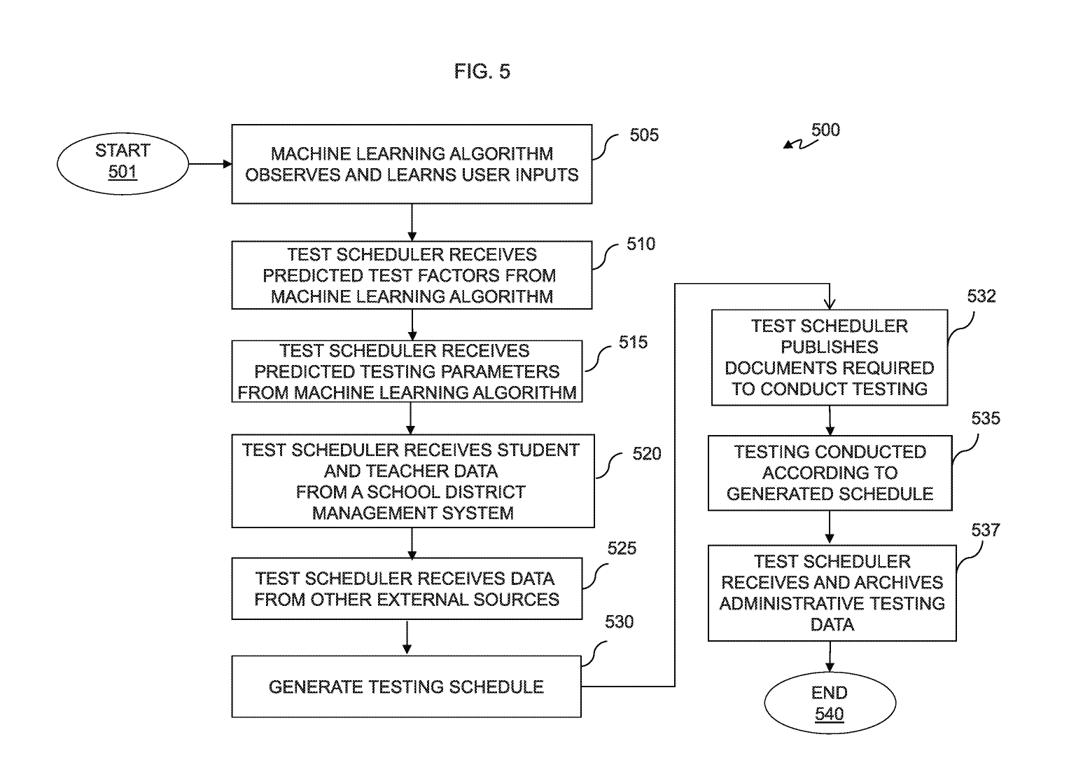

FIG. 5 illustrates a flow diagram of an embodiment of a method for creating a testing schedule and conducting a standardized test using a machine learning algorithm according to the created testing schedule carried out according to the principles of the disclosure.

### DETAILED DESCRIPTION

Standardized tests are used by many state educational agencies as a tool to measure what a student has learned at a certain grade and/or course level and how well each student is able to apply the knowledge and skills at a certain grade and/or course level. Each standardized test is generally given to all students in the target grade level or course across the state and/or school district. Generally each student is required to achieve a passing score before the student can move forward to the next grade/course level, and students in high school must pass certain tests in order to graduate. Certain grades may require multiple tests for various subjects or course levels and therefore multiple testing dates. Each campus providing the testing (the testing campus) must prepare a schedule for each standardized test according to various state or federal guidelines. In addition, each campus must monitor whether students pass or fail a test, and if necessary schedule follow up re-take exams.

Accordingly, the disclosure provides a computer-based test scheduling system for providing a testing schedule for each testing campus based on the inputs received. The inputs may come from a user at each campus, testing parameters, data received from a school district management system, and data from external sources. The inputs considered in generating a testing schedule include not only which students are taking which tests, but the testing and non-testing students' schedules, available staff and teachers to administer the testing and the teacher schedules, facility requirements, facility schedules, special student accommodations or designated supports, test administration data, and a multitude of other factors which must be considered for each testing schedule for each testing campus.

A test scheduling system according to the disclosure may include a computer program product configured to prepare a testing schedule according to details of the disclosure. A test scheduler apparatus and method for conducting testing are also provided. The test scheduling system may include a user interface where users can input various inputs to be considered in the preparation of a testing schedule. The inputs may include inputs from a user at a test campus. The inputs including substantially constant test factors, such as school district information, campus information, facility/room information and testing locations available. Testing parameters may also be defined, including test administration dates, which tests will be given, test inventory checklists provided by a test publisher, and test inventory available.

The test scheduling system may also include external data sources. A student management system at a school district level may be connected with the test scheduler to provide data via automated inputs and updates. The data which may be automatically updated may include student data—students enrolled and their individual identification data; students scheduled to take which tests; students not scheduled for testing; student demographics and special testing accommodations needed; student schedule information; teacher and staffing availability and requirements; and teacher schedules.

Variations in student schedules, teacher schedules, and testing accommodations needed for some students have heretofore been challenging to manually prepare. Not only do the students taking the tests schedules need to be considered, but also the schedules of the teachers and staff, the facility accommodations, and also the students who are not testing. For example, balancing the various special accommodations that may be required for certain students takes coordinated planning based on the roster of students taking each test and the testing rooms available. Special testing accommodations may include amplification devices, basic transcribing, Braille, calculation aids, content supports, a dictionary, extra time, individualized structured reminders, language and vocabulary supports, large print, manipulating test materials, math manipulatives, oral/signed administration, projection devices, spelling assistance, supplemental aids, complex transcribing, an extra day, a math scribe, and various other accommodations needed according to each student's needs. Accordingly, balancing all of the factors and inputs that go into a testing schedule to manually prepare a testing schedule has heretofore been time consuming and costly for one or more testing campus coordinators or staff positions. For example, the cost of standardized testing in Texas was over $236 million in 2014, which equals about $47 per student, with about $16 of those costs incurred at the state level and over $30 per student incurred at the district level. (See “Budget Development and Management—Urban district marginal cost associated with mandatory state testing,” Crow, J. E., & LaCost, B. (2015)., 35). However, the test scheduling system according to the disclosure is able to consider all of these factors in the preparation and planning of the testing schedule for each campus. In some implementations, the time spent by a testing coordinator was reduced by more than 50%. In other implementations, the time spent by a testing coordinator may be reduced about 90%. In embodiments using a machine learning algorithm as will be discussed below, the time spent on coordinating testing by a testing coordinator may be reduced by almost 99% once the machine learning algorithm is able to learn and anticipate the inputs previously received from a testing coordinator.

Thus, the disclosure advantageously improves the computer technology area of test scheduling by allowing a computer to perform a function previously not performable by a computer: generate a testing schedule by considering and weighting the plurality of inputs as disclosed herein.

Turning now to the figures, FIG. 1 illustrates a diagram of an embodiment of a test scheduling system 100 constructed according to the principles of the disclosure. The test scheduling system 100 is configured to allow a user, such as a campus test coordinator or other administrative/data entry personnel to input a plurality of factors that impact the testing schedule for a subject campus. The test scheduling system 100 includes a test scheduler 110 connected with at least one user interface for entering a plurality of testing factors into the system 100. The system 100 may also include an interface 132 for connecting the test scheduler 110 with a school district management system, which may provide automatic updates to the test scheduler.

The user interface is configured to receive a plurality of testing factors which are considered when determining a testing schedule. The user interface may include one or more computer devices configured to communicate with the test scheduler 110. The user interface may be a conventional communication device such as a smart phone, a tablet, a pad, a laptop, a desktop, or another device capable of interfacing with a user and communicating via wireless connections, wired connections or a combination thereof. The user interface may also be a web-based interface provided by the state or individual school district which may then be accessed at each testing campus. After testing factor data is entered by the user(s), the user interface thereafter communicates the data to the test scheduler 110 for consideration in the production of the testing schedule.

The test scheduler 110 may be a separate computing device apart from the user interface, or in some embodiments may be incorporated into the same computing device or computing system as the user interface. In some embodiments, the test scheduler 110 may be housed on a network at either the campus, district, or state level. In one embodiment, the test scheduler 110 is implemented on a server that includes the necessary logic and memory to perform the functions disclosed herein. Accordingly, the test scheduler 110 can also be a website hosted on a web server, or servers, and that is accessible via the World Wide Web. A Uniform Resource Locator (URL) can be used to access the various webpages of the test scheduler 110. In some embodiments, the test scheduler 110 can be implemented as a Software as a Service (SaaS).

The test scheduler 110 may include at least one interface 132, a memory 134 and a processor 136. The interface 132 is a component or device interface configured to couple the test scheduler 110 to the user interface and communicate therewith. The interface 132 may also be configured to connect the test scheduler 110 with the district management system and any other external data sources, or in some embodiments, a second interface may be required. The interface 132 can be a conventional interface that communicates with the user interface and district management system according to standard protocols.

The memory 134 is configured to store the various software aspects related to the test scheduler 110. Additionally, the memory 134 is configured to store a series of operating instructions that direct the operation of the processor 136 when initiated. The memory 134 is a non-transitory computer readable medium. The memory 134 can be the memory of a server.

The processor 136 is configured to direct the operation of the test scheduler 110. As such, the processor 136 includes the necessary logic to communicate with the interface 132 and the memory 134 and perform the functions described herein to prepare a testing schedule based on the plurality of inputs received by the test scheduler 110. The processor 136 can be part of a server.

FIG. 2 illustrates a block diagram of an embodiment of a test scheduler 200 constructed according to the principles of the disclosure. The test scheduler 200 or at least a portion thereof can be embodied as a series of operating instructions stored on a non-transitory computer-readable medium that direct the operation of a processor when initiated. The test scheduler 200 can be stored on a single computer or on multiple computers. The various components of the test scheduler 200 can communicate via wireless or wired conventional connections. A portion of the test scheduler 200 can be located on a server and other portions of the test scheduler 200 can be located on a computing device or devices that are connected to the server via a network or networks.

The test scheduler 200 can be configured to perform the various functions disclosed herein including receiving inputs from a user interface, from a district management system, and inputs which may be stored in a memory, and considering all of the received inputs in preparing a detailed testing schedule for each testing campus. The detailed schedule may provide at least a testing roster of which students are taking which tests, a schedule of rooms for each test, which teachers are assigned to each room, special testing accommodations needed for certain students, testing instructions, and a schedule and plan for students not testing. In one embodiment, at least a portion of the test scheduler 200 is a computer program product. The test scheduler 200 includes a user interface 220, test scheduling code, a memory, and may include a network interface.

The user interface 220 is configured to receive inputs from one or more users at a testing campus, the inputs relating to the various factors that may impact the testing schedule for the campus. The user interface 220 or at least a portion thereof can be provided on a display or screen of user devices to allow interaction between users and the test scheduler 200. In one embodiment, the user interface 220 includes a web page provided on a user device. The interaction via the user interface 220 includes manual entry of certain data points. A keyboard, keypad, mouse, or other input device can be used for entering the data points. Some data points may stay substantially constant, such as district information, campus information, and campus room information and facility layout, and as such, may not require a substantial amount of data entry beyond an initial setup, except as required for updates and the like.

The interface 232 is a component or device interface configured to couple the test scheduler 200 to the user interface 220 and communicate therewith. The interface 232 may also be configured to connect the test scheduler 200 with a district management system 240, or in some embodiments, a second interface, such as network interface 238 may be included. The interface 232 and second interface 238 may each be a conventional interface that communicates with the user interface 220 and district management system 240 according to standard protocols.

The memory 234 is configured to store the various software aspects related to the test scheduler 200. Additionally, the memory 234 is configured to store a series of operating instructions that direct the operation of the processor 236 when initiated. The memory 234 is a non-transitory computer readable medium. The memory 234 can be the memory of a server.

The processor 236 is configured to direct the operation of the test scheduler 200. As such, the processor 236 includes the necessary logic to communicate with the interface 232, second interface 238, and the memory 234 and perform the functions described herein to prepare a testing schedule based on the plurality of inputs received by the test scheduler 200. The processor 236 can be part of a server.

Turning now to FIG. 3, there is illustrated an embodiment of a method 300 for conducting a standardized test according to aspects of the disclosure. In one embodiment, at least a portion of the method 300 can be performed by a computing device or processor as disclosed herein. A computing device may include the necessary logic circuitry to carry out at least a portion of the method 300. In one embodiment, the method 300 or at least a portion thereof may be embodied as a series of operating instructions that are stored on a non-transitory computer readable medium and used to direct the operation of a processor when initiated thereby. As indicated below, a test scheduler as disclosed herein can perform at least some of the steps of the method 300. The method 300 begins in a step 301.

In a step 305, a user interface is provided to at least one user at a testing campus, wherein the user interface is connected with a test scheduler, such as test scheduler 200 described herein.

In a step 310, the test scheduler receives test factors for the testing campus that are substantially constant, not subject to frequent change. The test scheduler receives the test factors via the user interface connected with the test scheduler. A user can input the test factors via the user interface. These test factors may include, but are not limited to the following: school district information pertinent to the testing and/or required by states for identification and reporting information; campus information; facility information for the campus, including list of classrooms, classroom size, room amenities, including computers, and layout; special accommodation amenities and supports available at each facility, and potential alternate testing locations, which may include areas not listed as campuses by the district.

In a step 315, the test scheduler receives testing parameters from the user. The testing parameters may include, which tests are to be given; test administration dates; testing medium—given online, via computer, on paper, etc.; test inventory checklist—items the testing publisher will provide to each school district; and an inventory of tests on hand. In some embodiments, the test scheduler may have a memory with certain testing parameters pre-loaded or entered, such that a user at each campus need not enter certain testing parameter data. In some embodiments, the test scheduler may receive some or all testing parameters via an upload.

In a step 320, the test scheduler receives student and teacher data from a school district management system. The student and teacher data may include the following: a listing of students currently enrolled at the testing campus, including at least the student name and ID number; student schedule information, student demographic information as required by state education boards for identification purposes, including enrollment in special education programs, assisted learning programs, career and technical education programs, multi-lingual education, and various other special education or accommodation needs available for each district. The student data may also include which students require special testing accommodations. The test scheduler may also receive inputs related to teachers currently employed at the campus and teacher schedule information, including current course and room assignments. In some embodiments, the test scheduler may be configured to receive updates from the district student management system on a regular periodic basis. In some embodiments, the periodic updates may be at least once per day, preferably on a nightly basis. In other embodiments, the user may be able to manually request an update.

In one embodiment, the method 300 includes verifying from the received teacher data, whether the teachers are certified, meaning that all teachers have received state and/or district required training. A user at a school district may either provide a statement in the teacher data that all teachers are certified, or may provide an oath for a teacher as part of the teacher data. In one embodiment, the test scheduler may provide a training module, whereby teachers may attend a virtual training session via a computing device, and upon completion of the virtual training session, complete and sign a digital oath. In one embodiment, the training module may include state required training. In another embodiment, the test scheduler may include an option whereby the user may modify the training module, or upload or otherwise provide a customized training module, specific to the user's campus or school district.

In a step 325, the test scheduler receives additional data from one or more external sources that is not available from the School District Management System. One such example of an external source may include PAYPAMS, a signup and payment system used by several school districts in Texas. This additional data may be manually or automatically uploaded to the test scheduler via an interface of the test scheduler. The additional data may include specific student testing accommodations; past performance data for the test, including each individual student's performance and collective student performance. The additional data may also include inputs received via self-registration, where in some situations, a student or parent may need to self-register for a specific test, including submitting payment.

In a step 330, the test scheduler generates a testing schedule based on all of the inputs from the user, uploads, school district Student Management system, and any other data received from any external sources. Part of the generating includes the test scheduler organizing the inputs and processing the data to prepare a schedule. In some embodiments, the organizing of the inputs may include verifying that all inputs are in compliance with district or state regulations related to teacher certification, student accommodation requirements and designated support requirements. The schedule includes at least which students are assigned to each room or facility, teacher or staff assignments, special testing accommodations, and schedules for students not participating in testing. In one embodiment, a testing schedule is generated by executing a decision tree algorithm that generates the test schedule employing, for example, the test factors, testing parameters, and data received in steps 310 to 325.

In a step 332, the test scheduler publishes documentation required to enact the testing schedule. The documentation can include the following or any combination thereof: testing rosters of which students are taking what test, when, and where; materials controls—which booklets and documents are to be used by which students; a master testing schedule for the campus, which may include a master list of all students and locations for each test to be given; non-testing rosters which identify which students are not testing and may be displaced by testing; non-testing schedules which identify a schedule for the displaced, non-testing students; teacher schedules identifying a list of each teacher assigned to each test; student accommodations required—identifying which students require special accommodations, what special accommodations are required, special accommodation amenities available for each facility, and which rooms these students will be placed; state data exchange uploads required reporting documents; inventory tracking reports and labels; student/parent communication information, informing the students of their testing schedule; teacher/proctor communication information, informing teachers and proctors of their test administration schedules; any teacher/proctor training materials; and audit reports which may be used for long term documentation purposes. The test scheduler is configured to provide a testing schedule for each testing campus such that a more efficient use of campus staff time, facility resources, and overall management of student schedules may be achieved during test days than heretofore has been achievable by manually creating and manipulating a testing schedule. In some embodiments, some of the documentation may be provided electronically for sending to a computing device at the testing campus and/or school district administration facility. In some embodiments, the documentation can be provided electronically for batch printing and/or batch e-mail distribution.

In a step 335, testing is conducted according to the generated test schedule.

After testing is conducted in step 335, in a step 337, the test scheduler receives administrative data related to test administration of the conducted testing and archives the received administrative data. The information may be received from a user and/or via an upload. The archived administrative documentation may include seating charts indicating where students sat in each room; oaths or declarations signed by the students and/or teachers and proctors; materials control forms; and other documentation that may be required by each school district or state. After step 337, the method 300 continues to step 340 and ends.

FIG. 4 illustrates a flow diagram of an example of a method 400 to complete a portion of the steps of the test scheduling method 300 illustrated in FIG. 3. The method 400 corresponds to an algorithm that can be executed by a processor, such as processor 236. The method 400 can vary depending on various inputs received according to the corresponding algorithm. A test scheduler as disclosed herein can execute the algorithm to perform the method 400. The algorithm can be a decision tree algorithm that when executed generates prompts and questions based on received inputs to generate unique test schedules. The method 400 provides an example of one of many algorithms that can be employed for test scheduling as disclosed herein. The method 400 illustrates questions, answers, and user prompts which may occur between steps 320 and 330 of the method as illustrated in FIG. 3 to execute a testing schedule, in this example, a schedule for an Algebra I test. The method 400 starts in a step 420.

In a step 421, a user is prompted to configure a test schedule for an Algebra I test. The user can be prompted via a user interface, such as the user interface 220. In a step 422, the names of students to test are received. The user can manually add the students, or can select students from the data uploaded from the district management system. In one embodiment, a list of students for testing is received and the user can alter the students based on, for example, certain Algebra I classes. In one embodiment, the user is prompted to review certain students which are improperly scheduled for the Algebra I test or are missing from the test schedule due to a previous test failure. As such, the method 400 advantageously considers specific adjustments when generating the test schedule.

At a step 423a, a prompt is generated asking if any additional students need to be added into the testing schedule. The additional students may include students re-taking the test or are taking a different grade/math level and may be testing ahead or behind the student's current math level. If there are additional students, the names of the additional students are received in a step 423b. The user can either manually input these students, or can select them as entered by another external source.

If there are no additional students to add, or additional student names have been received, in a step 424, a prompt is generated to select one or more rooms for testing. The prompt can suggest rooms based on data already received, or the user can manually select or add additional rooms. If there are any students requiring special testing accommodations, the prompt may suggest rooms based on the facility accommodations available, or the user may be asked to manually select room assignments for these students. For example, the system may prompt the user with certain students needing a small group testing environment in order to suggest a testing room for these students. Once the rooms are selected, in a step 425, a prompt is generated to assign students to the selected rooms. The method 400 can generate a suggested assignment based on the received inputs. The assignment may be done, for example, alphabetically, by class rosters, home room assignments, students needing special accommodations, or by random selection. The user can manually enter the room assignments, or can confirm the suggested room assignments generated by the method 400. The student room assignments are received and used to schedule students to testing rooms.

In a step 426, a prompt is generated to assign faculty to administer tests in each of the selected rooms. The method 400 can suggest faculty for assignment based on teacher schedules and information already entered into the system. The user can manually assign teachers or adjust the suggested assignments. The faculty assignments are received and used to schedule the faculty to the testing rooms. In some embodiments, the method 400 can automatically assign students and faculty into rooms without user approval based on the received inputs. In some embodiments, the method 400 can include teacher certifications so that the user can verify an assigned teacher for a selected room is certified to administer the test assigned to the selected room.

Once students and faculty are assigned to testing rooms, in a step 427, a prompt is generated to provide an inventory of available test booklets. The method 400 can create an inventory based on received data and the user can verify the created inventory. In a step 428, a prompt is generated to specify how the booklets are to be assigned to the students. The method 400 can provide a suggested assignment of test booklets to students with the appropriate tracking or serial numbers. The user can verify or alter the suggested assignments. As with the students and faculty, in some embodiments, the method 400 can automatically assign test booklets to students based on the received inputs. The method 400 can also verify, either automatically or with user inputs via a prompt, that students needing special testing accommodations, such as a specific language test booklet, were satisfied. Thus, the method 400 can verify, even automatically verify, that if “student A” needed special testing accommodations, student A was assigned the needed special testing accommodations.

At a step 429, a determination is made if there are any changes that could influence the created testing schedule. The method 400 can monitor external data sources to detect changes to student data, faculty data, accommodation and designated support data, etc. that could alter the testing schedule. If there are any data changes, the method 400 goes back to the affected step. In this example, a student moved into the district and needs to be added to the list of students taking the test. The method 400 accordingly goes back to step 423b for the user to enter the additional student and the remaining steps are updated accordingly. In some embodiments, the method 400 can automatically add the student and update the remaining steps.

If no data changes occur, or after any changes have been addressed and the user is ready to finalize the test, the test scheduler generates a testing schedule in a step 430. A confirmation for generating the testing schedule can be received from a user in response to a prompt generated by the method 400.

FIG. 5 illustrates yet another embodiment of a method 500 for conducting a standardized test carried out according to aspects of the disclosure. In one embodiment, at least a portion of the method 500 can be performed by a computing device as disclosed herein. A computing device may include the necessary logic circuitry to carry out the method 500. In one embodiment, the method 500 or at least a portion thereof may be embodied as a series of operating instructions that are stored on a non-transitory computer readable medium and used to direct the operation of a processor when initiated thereby. In one embodiment a test scheduler as disclosed herein, as indicated below in the various steps, can perform the method 500. The method 500 begins in a step 501.

The method 500, is similar to method 300 described herein, except for the test scheduler further includes a machine learning algorithm configured to observe the inputs made by the user. In a step 505, the machine learning algorithm observes and learns the inputs made by a user, such as substantially constant test factors received from a user in Step 310, and testing parameters received by a user in Step 315, over a certain period of time, such as, e.g., 3 years. After the certain period of time, the machine learning algorithm may be able to predict the test factor and testing parameter inputs, and thereafter provide predicted inputs to the test scheduler, such that no inputs are required by the user. In this embodiment, the test scheduler receives the predicted test factors from the machine learning algorithm in a Step 510.

In a step 515, the test scheduler receives predicted testing parameters from the machine learning algorithm. In some embodiments, the test scheduler may receive some or all testing parameters via an upload.

In a step 520, the test scheduler receives student and teacher data from a school district management system. The student and teacher data may include data similar to data described in conjunction with Step 320. In one embodiment, the test scheduler may verify from the received teacher data, whether the teachers are certified. In one embodiment, the test scheduler may provide a training module, whereby teachers may attend a virtual training session via a computing device, and upon completion of the virtual training session, complete and sign a digital oath.

In a step 525, the test scheduler may be configured to interact with one or more external sources to receive data not available from the School District Management System. This additional data may be manually or automatically uploaded to the test scheduler. The data received in Step 525 is similar to the data received in Step 325.

In a step 530, the test scheduler generates a testing schedule based on all of the inputs from the machine learning algorithm, uploads, school district Student Management system, and any other data received from any external sources. Part of the generating includes the test scheduler organizing the inputs and processing the data to prepare a schedule. The schedule includes at least which students are assigned to each room or facility, teacher or staff assignments, special testing accommodations, and schedules for students not participating in testing.

In a step 532, the test scheduler also publishes any documentation required to enact the testing schedule. The documentation may include the documentation as discussed hereinabove with Step 332. In one embodiment, the documentation may include a generated testing schedule sent to a user at a testing campus for approval. The user may make changes to the generated testing scheduled and the test scheduler thereafter receives any changes made by the user. The machine learning algorithm may be further configured to observe any changes made by the user and verify that the changes do not violate constraints such as pass/fail data or designated supports, and thereafter be able to predict the changes and adjust the testing schedule accordingly.

In a step 535, testing is conducted according to the generated test schedule.

After testing is conducted in step 535, in a step 537, the test scheduler receives administrative data related to test administration and archives the received administrative data. After step 537, the method 500 continues to step 540 and ends.

Accordingly, once the machine learning algorithm has observed and learned the user test factor inputs, testing parameters, and any changes made to the generated testing schedule, one embodiment of a test scheduler may be configured to prepare and generate a testing schedule with only minimal interaction from a user at a testing campus, thereby enabling the user to focus on other administrative and educational needs which benefit the students and school district. In addition, the school district may be able to combine multiple positions into one positions, such that one user may be able to support multiple testing campuses.

A portion of the above-described apparatus, systems or methods may be embodied in or performed by various, such as conventional, digital data processors or computers, wherein the computers are programmed or store executable programs of sequences of software instructions to perform one or more of the steps of the methods. The software instructions of such programs may represent algorithms and be encoded in machine-executable form on non-transitory digital data storage media, e.g., magnetic or optical disks, random-access memory (RAM), magnetic hard disks, flash memories, and/or read-only memory (ROM), to enable various types of digital data processors or computers to perform one, multiple or all of the steps of one or more of the above-described methods, or functions, systems or apparatuses described herein.

Portions of disclosed embodiments may relate to computer storage products with a non-transitory computer-readable medium that have program code thereon for performing various computer-implemented operations that embody a part of an apparatus, device or carry out the steps of a method set forth herein. Non-transitory used herein refers to all computer-readable media except for transitory, propagating signals. Examples of non-transitory computer-readable media include, but are not limited to: magnetic media such as hard disks, floppy disks, and magnetic tape; optical media such as CD-ROM disks; magneto-optical media such as floptical disks; and hardware devices that are specially configured to store and execute program code, such as ROM and RAM devices. Examples of program code include both machine code, such as produced by a compiler, and files containing higher level code that may be executed by the computer using an interpreter.

Those skilled in the art to which this application relates will appreciate that other and further additions, deletions, substitutions and modifications may be made to the described embodiments.

1. A test scheduler for generating testing schedules for standardized tests, comprising:
at least one non-transitory interface for receiving a plurality of inputs from a user and at least one external source; and
a processor stored on a non-transitory readable medium, the processor configured to perform a test scheduling algorithm to generate a testing schedule for a testing campus, wherein the test scheduling algorithm generates a series of input prompts to a user and a series of decisions based on the plurality of inputs, wherein one of the series of input prompts asks the user to select at least one testing room for testing;
wherein the plurality of inputs includes at least testing parameters, student testing accommodations required, and student and teacher data, the teacher data including at least a roster of teachers and teacher schedules;
wherein the at least one non-transitory interface is configured to receive regular periodic updates at from the at least one external source; and
wherein the test scheduling algorithm is configured to determine whether any changes have occurred to any of the plurality of inputs and if said changes have occurred, the test scheduling algorithm modifies the testing schedule based on said changes.

2. The test scheduler according to claim 1, wherein the at least one external source is a school district management system.

3. The test scheduler according to claim 2, wherein the test scheduler is configured to receive inputs and updates from the school district management system.

4. The test scheduler according to claim 1, wherein the plurality of inputs further include administrative data associated with the testing, wherein the processor is further configured to archive the administrative data.

5. The test scheduler according to claim 1, wherein the plurality of inputs further includes data received via the at least one interface from self-registration, entered by a student who will be testing, or by a parent of a student who will be testing.

6. The test scheduler according to claim 1, wherein the plurality of inputs further includes past performance data for each test, and past performance data for each student.

7. The test scheduler according to claim 1, further comprising a second interface, wherein the second interface is a network interface configured to communicate with the at least one external source.

8. A test scheduling system for generating testing schedules for standardized tests, comprising:
a test scheduler configured to generate a test schedule; and
at least one external computing device configured to supply student and teacher data to the test scheduler for the test schedule;
wherein the test scheduler includes:
at least one interface for receiving a plurality of inputs from the at least one external computing device, the at least one interface configured to receive periodic updates from the at least one external source;
a memory, the memory storing a test scheduling computer program product; and
a processor stored on a non-transitory computer readable medium, the processor configured to execute a test scheduling algorithm and prepare based thereon a testing schedule for a testing campus, wherein the test scheduling algorithm generates a series of input prompts and decisions based on the plurality of inputs, wherein one of the series of input prompts the user to select at least one testing room for testing;
wherein the plurality of inputs includes at least testing parameters, student testing accommodations required, and student and teacher data, the teacher data including at least a roster of teachers and teacher schedules; and
wherein the test scheduling computer program product is configured to determine whether any changes have occurred to any of the plurality of inputs and if said changes have occurred, the test scheduling computer program product modifies the testing schedule based on said changes.

9. The test scheduling system according to claim 8, wherein the at least one external source is a school district management system.

10. The test scheduling system according to claim 9, wherein the test scheduler is configured to receive inputs and updates from the school district management system.

11. The test scheduling system according to claim 8, wherein the plurality of inputs further include administrative data associated with the testing, wherein the processor is further configured to archive the administrative data in a memory of the test scheduling system.

12. The test scheduling system according to claim 8, wherein the plurality of inputs further includes data received via self-registration, entered by a student who will be testing, or by a parent of a student who will be testing.

13. The test scheduling system according to claim 8, wherein the plurality of inputs further includes past performance data for each test, and past performance data for each student.

14. The test scheduling system according to claim 8, further comprising a second interface, the second interface configured to communicate with the at least one external source.

15. A method for coordinating a standardized test, comprising:
receiving data for a testing campus, the data including at least school district information and campus information;
receiving testing parameters;
receiving student and teacher data from at least one external source on a periodic basis, the teacher data including at least a roster of teachers and teacher schedules;
receiving student testing accommodations required;
receiving past performance data for each test and student; and
preparing a testing schedule for the testing campus using the received data for the testing campus, the testing parameters, the student and teacher data, the student testing accommodations, and the past performance data;
wherein the preparing the testing schedule is performed by a processor stored on a non-transitory computer readable medium, wherein the processor is configured to execute a test scheduling algorithm and prepare based thereon a testing schedule for a testing campus, wherein the test scheduling algorithm generates a series of input prompts and decisions based on the received data for the testing campus, the testing parameters, the student and teacher data, the student testing accommodations, and the past performance data, wherein one of the series of input prompts asks the user to select at least one testing room for testing;
wherein the preparing the testing schedule includes determining whether any changes have occurred to any of the plurality of inputs and if said changes have occurred and modifying the testing schedule based on said changes.

16. The method according to claim 15, wherein the at least one external source is a school district management system.

17. The method according to claim 15, wherein the preparing the testing schedule includes organizing and processing the received data, testing parameters, student and teacher information, testing accommodations, and past performance data.

18. The method according to claim 15, further including archiving administrative data associated with the testing.

19. The method according to claim 15, further including receiving at least the student data via self-registration.

20. The method according to claim 15, wherein the receiving student testing accommodations required is received from a second external data source.
